(19) United States
(12) Patent Application Publication
(10) Pub. No.: US 2026/0143461 A1
(43) Pub. Date: May 21, 2026

(54) SYSTEMS AND METHODS FOR PROACTIVE BEAM FORMING BASED ON A LOCATION OF A NETWORK-CONNECTED DEVICE

(71) Applicant: Verizon Patent and Licensing Inc., Basking Ridge, NJ (US)

(72) Inventors: Christopher R. ALBANO, Medford, NJ (US); Yuk Lun LI, Morganville, NJ (US)

(73) Assignee: Verizon Patent and Licensing Inc., Basking Ridge, NJ (US)

(21) Appl. No.: 18/953,593

(22) Filed: Nov. 20, 2024

(51) Int. Cl. H04W 64/00; H04W 12/06; H04W 24/02

(52) U.S. Cl. CPC H04W 64/006; H04W 12/06; H04W 24/02

(57) ABSTRACT

A device may receive location data identifying a current location of a user equipment (UE) and traffic data associated with routes from the current location to a destination, and may retrieve historical data associated with travel times of the UE to the destination. The device may process the location data, the traffic data, and the historical data, with a model, to predict a time of arrival of the UE at the destination, and may determine that the UE is within a proximate distance of the destination based on the time of arrival. The device may provide, to a network device, an alert indicating that the UE is within the proximate distance and to cause the network device to generate a radio frequency signal for the UE.

### BACKGROUND

Wireless network connectivity, especially at boundary regions where different networks overlap, poses considerable challenges for users attempting to maintain continuous and reliable connections.

### BRIEF DESCRIPTION OF THE DRAWINGS

FIGS. 1A-1D are diagrams of an example associated with proactive beam forming based on a location of a network-connected device.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for proactive beam forming based on a location of a network-connected device.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) moving from one network coverage area, such as a mobile telecommunications network, to another network, like a home Wi-Fi network, frequently experiences delays and disruption in service. This is of particular concern at the edge of wireless network coverage areas, where signal quality may be compromised, and the transition between networks is less seamless. Such connectivity issues can impede timely access to network resources and result in service interruptions that are not just inconvenient but can also affect time-sensitive operations like phone calls or the use of smart home applications. Thus, current techniques for managing device performance on edges of multiple wireless networks consume computing resources (e.g., processing resources, memory resources, communication resources, and/or the like), networking resources, and/or other resources associated with failing to provide access to network resources, handling service interruptions caused by failing to provide access to network resources, preventing phone calls or use of smart home applications due to service interruptions, and/or the like.

Some implementations described herein relate to a mediator system that provides proactive beam forming based on a location of a network-connected device. For example, the mediator system may receive location data identifying a current location of a UE and traffic data associated with routes from the current location to a destination, and may retrieve historical data associated with travel times of the UE to the destination. The device may process the location data, the traffic data, and the historical data, with a model, to predict a time of arrival of the UE at the destination, and may determine that the UE is within a proximate distance of the destination based on the time of arrival. The device may provide, to a network device, an alert indicating that the UE is within the proximate distance and to cause the network device to generate a radio frequency signal for the UE.

In this way, the mediator system provides proactive beam forming based on a location of a network-connected device (e.g., a UE). For example, the mediator system may utilize location data of a UE, directional travel data of the UE, updated location data, alterations in traffic patterns, and environmental conditions to refine an estimated time of arrival at a destination (e.g., where a network transition occurs). Additionally, the mediator system may generate an authentication token in advance to enable a seamless and swift network transition for the UE. The mediator system may address network handoff challenges by implementing a proactive beam forming technique at a destination of the UE. With predictive analytics, the mediator system may generate commands to modify signal characteristics at the destination, such as directionality and power, in anticipation of arrival of the UE at the destination, thus minimizing the time that the UE requires to locate and authenticate with the network. Thus, the mediator system may conserve computing resources, networking resources, and/or other resources that would have otherwise been consumed by failing to provide access to network resources, handling service interruptions caused by failing to provide access to network resources, preventing phone calls or use of smart home applications due to service interruptions, and/or the like.

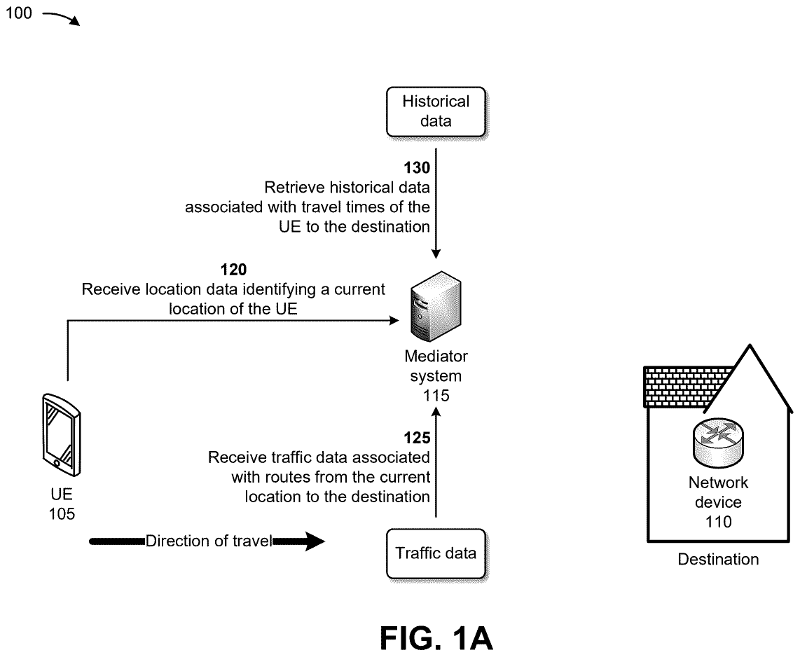

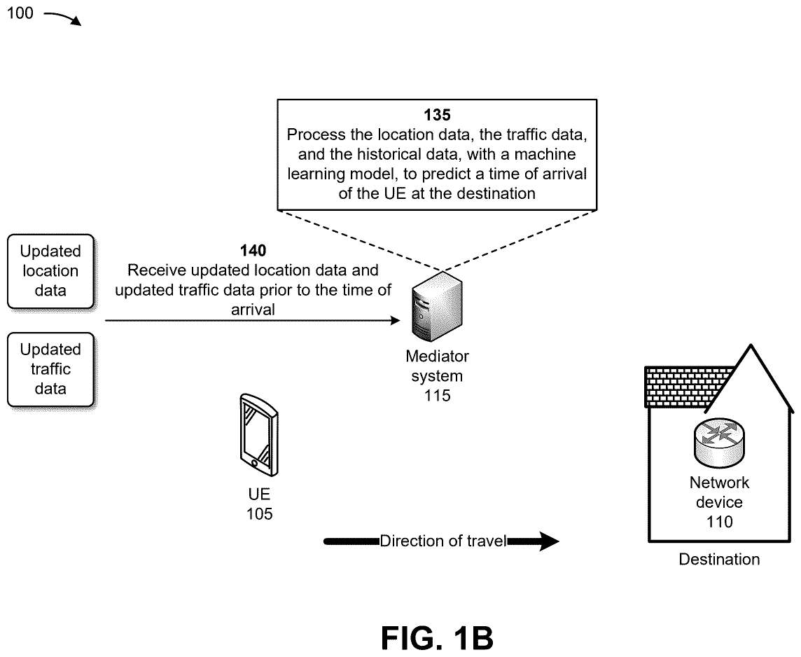

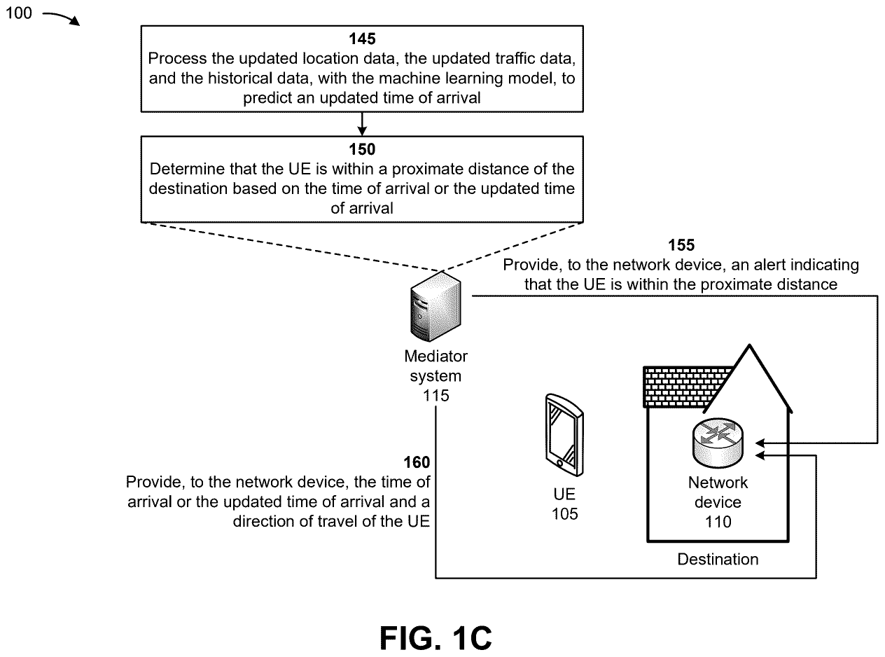

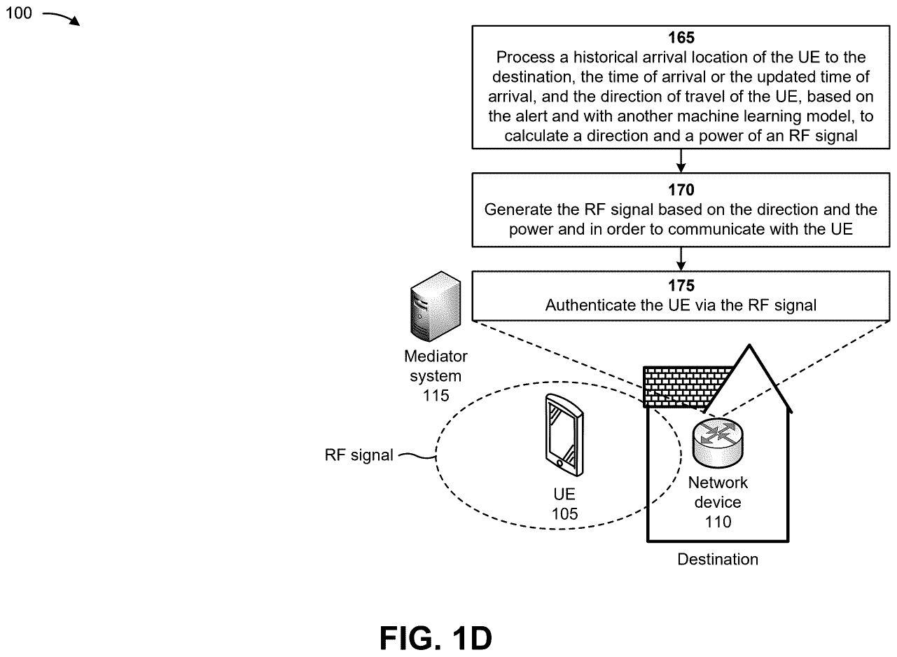

FIGS. 1A-1D are diagrams of an example 100 associated with proactive beam forming based on a location of a network-connected device. As shown in FIGS. 1A-1D, the example 100 includes a UE 105 (e.g., provided in a vehicle by a passenger or a driver, connected to a vehicle system, and/or the like), a network device 110 (e.g., provided at a destination, such as a home), and a mediator system 115. Further details of the UE 105, the network device 110, and the mediator system 115 are provided elsewhere herein.

As shown by FIG. 1A, and by reference number 120, the mediator system 115 may receive location data identifying a current location of the UE 105. For example, the mediator system 115 may obtain real-time location data from the UE 105, which may include coordinates derived from a global positioning system (GPS) or another positioning system. In some implementations, the location data may include a latitude, a longitude, an elevation, a positional accuracy, a time stamp, movement metrics, and/or the like of the UE 105. The latitude and the longitude may include fundamental elements of geographic coordinates that represent a position of the UE 105 on the Earth's surface. The elevation may include a height above or below a reference point, such as sea level. The positional accuracy may include a horizontal accuracy indicating a probable accuracy of the latitude and longitude data and a vertical accuracy indicating a probable accuracy of the elevation data. The time stamp may indicate an exact time at which the location data is recorded, which may be utilized for time-based calculations, such as predicting a time of arrival. The movement metrics may include a speed metric identifying a rate at which the UE 105 is moving and a direction or heading metric identifying a compass direction in which the UE 105 is moving.

In some implementations, the mediator system 115 may track the location data of the UE 105 via network tracking (e.g., cell tower triangulation or trilateration). Network tracking may provide a less accurate current location of the UE 105, but may require no input from the UE 105. Alternatively, the mediator system 115 may receive the location data directly from the UE 105, which may provide a more accurate location of the UE 105 (e.g., via a GPS that provides high accuracy using satellite signals). In some implementations, the mediator system 115 may receive location data from nearby Wi-Fi networks (e.g., Wi-Fi positioning) or from short-range signals from Bluetooth beacons. In some implementations, the location data may also include the stationary location of the destination and the network device 110.

As further shown in FIG. 1A, and by reference number 125, the mediator system 115 may receive traffic data associated with routes from the current location to the destination. For example, the mediator system 115 may receive the traffic data associated with the routes from the current location to the destination from various data sources, such as traffic management systems, navigation systems, crowdsourced data systems, and/or the like. The traffic data may include route options from the current location to the destination, estimated travel times from the current location to the destination, current traffic conditions associated with the route options (e.g., data about current traffic flow and congestion levels on various roads and highways, such as data identifying average speeds, traffic jams, and bottlenecks), accidents and incidents associated with the route options (e.g., reports of road accidents, construction work, and other incidents like police activity or road closures that may impact traffic), traffic signals and stop signs associated with the route options (e.g., data identifying locations and statuses of traffic signals and stop signs), historical traffic data (e.g., average travel times and peak traffic patterns), road network data (e.g., road types and conditions, speed limits, data about a quantity of lanes, lane usage, and lane closures), and/or the like.

As further shown in FIG. 1A, and by reference number 130, the mediator system 115 may retrieve historical data associated with travel times of the UE 105 to the destination. For example, the historical data may include previous travel records of the UE 105 to the destination. The historical data may include patterns, such as typical departure times, commonly used routes, and average travel durations of the UE 105 to the destination. The historical data may include data identifying typical approach patterns of the UE 105 to the destinations, such as common parking spots of the vehicle (e.g., the UE), variations of the typical approach patterns due to traffic, and/or the like. For example, the historical data may indicate whether the user of the UE 105 typically parks the vehicle in a garage or on the street.

Additionally, or alternatively, the mediator system 115 may receive environmental data associated with the UE 105 and/or the network device 110. The environmental data may include data identifying weather conditions (e.g., temperature, humidity, precipitation, and/or the like), signal interference, physical obstructions, and/or the like. In some implementations, the environmental data may impact a prediction of a time of arrival of the UE 105 to the destination and may affect radio frequency (RF) signal transmissions by the network device 110. For example, higher humidity levels may attenuate Wi-Fi signals, which may prompt the mediator system 115 to increase transmission power or switch frequency bands of the network device 110 to sustain connection quality.

In some implementations, the mediator system 115 may include a data structure (e.g., a database, a table, a list, and/or the like) that may store the historical data, the location data, the traffic data, the environmental data, and/or the like. The data structure may be continuously updated with real-time data received from various sources, including traffic management systems, GPS modules, and weather forecasting systems.

As shown by FIG. 1B, and by reference number 135, the mediator system 115 may process the location data, the traffic data, and the historical data, with a model, to predict a time of arrival of the UE 105 at the destination. For example, the mediator system 115 may utilize a machine learning model to analyze real-time location data, current traffic conditions, and historical travel patterns associated with the UE 105 to generate an accurate estimate of the time of arrival of the UE 105 at the destination. In some implementations, the mediator system 115 may dynamically adjust the predicted time of arrival as new data is received by the mediator system 115. For example, the mediator system 115 may refine the predicted time of arrival in real-time as updated location data is received (e.g., the vehicle utilizes an unexpected route), as updated traffic data is received (e.g., an accident is reported), based on changes in a speed and a direction of the UE 105, and/or the like.

In some implementations, the mediator system 115 may receive environmental data identifying environmental conditions associated with the UE 105 and/or the network device 110, and may process the environmental data, the location data, the traffic data, and the historical data, with the model, to predict the time of arrival of the UE at the destination. Additionally, or alternatively, the mediator system 115 may utilize the environmental data to generate a recommended direction and a recommended power of a radio frequency signal to be generated by the network device 110 for the UE 105 at the time of arrival. For example, adverse weather conditions, such high humidity, rain, or snow, may necessitate a higher power for maintaining signal integrity.

Additionally, or alternatively, the mediator system 115 may receive, from the UE 105 and/or the network device 110, feedback associated with the time of arrival predicted by the model. For example, the feedback may include an actual time of arrival of the UE 105 at the destination, which may vary from the predicted time of arrival due to unexpected traffic disruptions or route changes. The mediator system 115 may utilize the feedback to update the historical data and to retrain the model. For example, the feedback may enable continuous refinement and improvement of the model's accuracy in predicting arrival times and optimizing connectivity.

In some implementations, the machine learning model may include a linear regression model that predicts the time of arrival as a linear function of one or more independent variables (e.g., current location, speed, and traffic conditions); a random forest model that uses multiple decision tree models to improve accuracy and robustness; a gradient boosting machine model that builds models sequentially, with each new model correcting errors made by previous models; a neural network model (e.g., a recurrent neural network (RNN) model or a long short-term memory (LSTM) network model); a support vector machine model; and/or the like.

In some implementations, the mediator system 115 may provide predictive data to the network device 110, enabling pre-emptive measures to optimize signal strength and direction as the UE 105 approaches the destination. The predictive data may include, but is not limited to, the estimated arrival time, direction of travel, and historical trends related to past travel patterns of the UE 105.

As further shown in FIG. 1B, and by reference number 140, the mediator system 115 may receive updated location data and updated traffic data prior to the time of arrival. This step ensures that the predictions remain accurate as conditions change. For example, the mediator system 115 may continuously receive the updated location data and the updated traffic data so that the mediator system 115 may make real-time adjustments to the estimated time of arrival. This may enable the mediator system 115 to maintain the accuracy of the time of arrival prediction, improve seamlessness of network transitions, and optimize signal generation by the network device 110 (e.g., beam forming) as the UE 105 approaches the destination. The updated location data may include data that continuously tracks the current location of the UE 105 as the UE 105 moves toward the destination, data identifying a change in the direction of travel of the UE 105, data identifying a change in the speed of the UE 105, data identifying an unexpected route utilized by the UE 105, and/or the like. The updated traffic data may include data identifying changed traffic conditions (e.g., an unexpected road closure or heavy traffic), changed weather conditions, and/or the like.

As shown by FIG. 1C, and by reference number 145, the mediator system 115 may process the updated location data, the updated traffic data, and the historical data, with the model, to predict an updated time of arrival. For example, the mediator system 115 may utilize the model to analyze real-time updates to the location data and the traffic data, as well as the historical data, to refine the prediction of the time of arrival of the UE 105 at the destination. This real-time adjustment may ensure that any changes in travel conditions or routes are accounted for, and may optimize the time of arrival estimate. In some implementations, the mediator system 115 may utilize the environmental data with the updated location data, the updated traffic data, and the historical data to calculate the updated time of arrival of the UE 105 at the destination. For example, the model may factor in weather conditions such as humidity that can affect radio frequency propagation. This inclusion of diverse variables may enable more accurate predictions of signal performance and arrival times, allowing the network device 110 to make informed adjustments to maintain optimal connectivity.

Additionally, or alternatively, the mediator system 115 may authenticate the UE 105 (e.g., for utilization with the network device 110) prior to the time of arrival or the updated time of arrival. For example, as the mediator system 115 predicts the time of arrival or the updated time of arrival of the UE 105, the mediator system 115 may authenticate the UE 105 instead of the network device 110 authenticating the UE 105 at the time of arrival or the updated time of arrival. This may prevent any authentication delays for the UE 105 and may ensure connectivity as soon as the UE 105 enters a signal range of the network device 110.

As further shown by FIG. 1C, and reference number 150, the mediator system 115 may determine that the UE 105 is within a proximate distance of the destination based on the time of arrival or the updated time of arrival. For example, the mediator system 115 may continually assess the predicted time of arrival. Upon determining that the UE 105 will arrive imminently at the destination or has arrived within a predefined proximity to the destination, the mediator system 115 may determine that the UE is within the proximate distance of the destination. The proximate distance may include a distance in which the UE 105 may receive a radio frequency signal generated by the network device 110 and may communicate with the network provided by the network device 110 instead of or in addition to a telecommunications network. The mediator system 115 may receive or determine the distance that a radio frequency signal (e.g., generated by the network device 110) may reach (e.g., in meters, kilometers, and/or the like) and be received by the UE 105. In some implementations, the mediator system 115 may utilize the proximate distance when calculating the time of arrival of the UE 105 at the destination.

As further shown in FIG. 1C, and by reference number 155, the mediator system 115 may provide, to the network device 110, an alert indicating that the UE 105 is within the proximate distance. For example, when the mediator system 115 determines that the UE 105 is within a proximate distance of the destination, the mediator system 115 may generate the alert indicating that the UE 105 is within the proximate distance. The mediator system 115 may provide the alert to the network device 110. The alert may notify the network device 110 of the imminent arrival of the UE 105, and may cause the network device 110 to prepare for seamless connectivity with the UE 105.

In some implementations, in addition to providing the alert to the network device 110, the mediator system 115 may determine a direction and a power of a radio frequency signal to be generated by the network device 110 in order to communicate with the UE 105. The mediator system 115 may provide data identifying the direction and the power of the radio frequency signal to the network device 110, and the network device 110 may generate the radio frequency signal with the direction and the power. The generated radio frequency signal may facilitate establishment of a secure communication link between the UE 105 and the network device 110.

In addition to alerting the network device 110, the mediator system 115 may also send an alert to the UE 105 as the UE 105 approaches the destination, prompting the UE 105 to prioritize a search for the network device 110. Based on the alert, the UE 105 may execute connection procedures to actively look for a specific service set identifier (SSID) associated with the network device 110, reducing the time taken to establish a connection.

As further shown in FIG. 1C, and by reference number 160, the mediator system 115 may provide, to the network device 110, the time of arrival or the updated time of arrival and a direction of travel of the UE 105. For example, along with the alert, the mediator system 115 may provide, to the network device 110, details about the UE 105's expected arrival time and travel direction. The time of arrival or the updated time of arrival and the direction of travel of the UE 105 may enable the network device 110 to appropriately focus the radio frequency signal for optimal connection with the UE 105. In some implementations, the network device 110 may process the time of arrival or the updated time of arrival and a direction of travel of the UE 105, with another machine learning model, to predict and prepare for arrival of the UE 105. For example, the model may predict radio frequency signal strength and frequency bands, and the network device 110 may initiate beam forming and adjusting signal strength and frequency bands in anticipation of the arrival of the UE 105.

As shown by FIG. 1D, and by reference number 165, the network device 110 may process a historical arrival location of the UE 105 to the destination, the time of arrival or the updated time of arrival, and the direction of travel of the UE 105, based on the alert and with another machine learning model, to calculate a direction and a power of a radio frequency signal (e.g., a beam). For example, the network device 110 may utilize historical data regarding where the UE 105 typically arrives (e.g., on a street, in a driveway, in a garage, and/or the like), the predicted time of arrival, and the direction of travel of the UE 105 to determine optimal direction and power settings for the radio frequency signal. This may enable the network device 110 to provide more efficient and reliable radio frequency signal generation targeted toward the UE 105. For example, the network device 110 may configure the radio frequency signal in a way that optimally directs the signal toward the UE 105, ensuring that the signal strength and clarity are maintained as the UE 105 moves toward the network device 110. In some implementations, the network device 110 may utilize the environmental data when calculating the direction and the power of the radio frequency signal (e.g., to adjust for parameters, such as temperature, humidity, and/or the like, that affect signal transmission).

In some implementations, the machine learning model utilized by the network device 110 may include a linear regression model that calculates the direction and the power of the radio frequency signal as a linear function of one or more independent variables; a random forest model that uses multiple decision tree models to improve accuracy and robustness; a gradient boosting machine model that builds models sequentially, with each new model correcting errors made by previous models; a neural network model (e.g., an RNN model or an LSTM network model); a support vector machine model; and/or the like.

In some implementations, the mediator system 115 may process the historical arrival location of the UE 105 to the destination, the time of arrival or the updated time of arrival, and the direction of travel of the UE 105, with the machine learning model, to calculate the direction and the power of the radio frequency signal. In such implementations, the mediator system 115 may instruct the network device 110 to generate the radio frequency signal with the calculated direction and power.

As further shown in FIG. 1D, and by reference number 170, the network device 110 may generate the RF signal based on the direction and the power and in order to communicate with the UE 105. For example, the network device 110 may generate a radio frequency signal (e.g., based on the direction and the power) that ensures robust and high-quality communication with the UE 105 as the UE 105 nears the destination. The network device 110 may include a phased array antenna system that provides variable directionality and power levels to RF signals. In some implementations, the network device 110 or the mediator system 115 (e.g., via instructing the network device 110) may proactively adjust configurations to enhance connectivity as the UE 105 nears the destination. This may include increasing transmission power and switching frequency bands to ensure robust signal strength or providing a security element to ignore or block one or more particular UEs approaching a destination. For example, if the network device 110 determines that the UE 105 is approaching the destination from an area with weak cellular and Wi-Fi signals, the network device 110 may preemptively switch to a lower frequency band, such as 2.4 gigahertz (GHz), known for longer range, while increasing transmission power. This optimization may ensure that the UE 105 promptly connects to the network device 110 without a delay, thereby minimizing any disruption in network-dependent activities like making phone calls or operating smart devices within the destination.

Additionally, or alternatively, the network device 110 may prevent premature engagement of beam forming in scenarios involving slow-moving or high traffic near the destination, which may otherwise lead to inefficient utilization of network resources. For instance, the network device 110 may verify prerequisites before initiating proactive measures, such as confirming an identity of the UE 105, a typical arrival time, and a speed of approach. By ensuring that these conditions are met, the network device may prevent unnecessary beam forming actions when traffic is merely passing by the destination at a slow pace.

As further shown in FIG. 1D, and by reference number 175, the network device 110 may authenticate the UE 105 via the RF signal. For example, the network device 110 may authenticate the UE 105 in order to enable seamless network handoff and ensure that the UE 105 is recognized and granted access without delay as the UE 105 transitions into the range of the network device 110. In some implementations, the mediator system 115 may authenticate the UE 105 prior to the time of arrival of the UE 105 at the destination. For example, the mediator system 115 may provide an authentication token to the UE 105 based on determining that the UE 105 is within the proximate distance of the destination. The UE 105 may utilize the authentication token to authenticate the UE 105 with the network device 110. The authentication token may validate and confirm the identity of the UE 105 to the network device 110, and may ensure secure and smooth connectivity. Additionally, or alternatively, when the UE 105 is in proximity of the network device 110, the mediator system 115 may instruct the UE 105 to prioritize searching for the RF signal from the network device 110. This may ensure reduced detection versus authentication timing for the UE 105 and may reduce a timing of the connection establishment process when the UE 105 is near the destination.

In this way, the mediator system 115 provides proactive beam forming based on a location of a network-connected device (e.g., a UE 105). For example, the mediator system 115 may utilize location data of a UE 105, directional travel data of the UE 105, updated location data, alterations in traffic patterns, and environmental conditions to refine an estimated time of arrival at a destination (e.g., where a network transition occurs). Additionally, the mediator system 115 may generate an authentication token in advance in order to enable a seamless and swift network transition for the UE 105. The mediator system 115 may address network handoff challenges by implementing a proactive beam forming technique at a destination of the UE 105. With predictive analytics, the mediator system 115 may generate commands to modify signal characteristics at the destination, such as directionality and power, in anticipation of arrival of the UE 105 at the destination, thus minimizing the time that the UE 105 requires to locate and authenticate with the network. Thus, the mediator system 115 may conserve computing resources, networking resources, and/or other resources that would have otherwise been consumed by failing to provide access to network resources, handling service interruptions caused by failing to provide access to network resources, preventing phone calls or use of smart home applications due to service interruptions, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

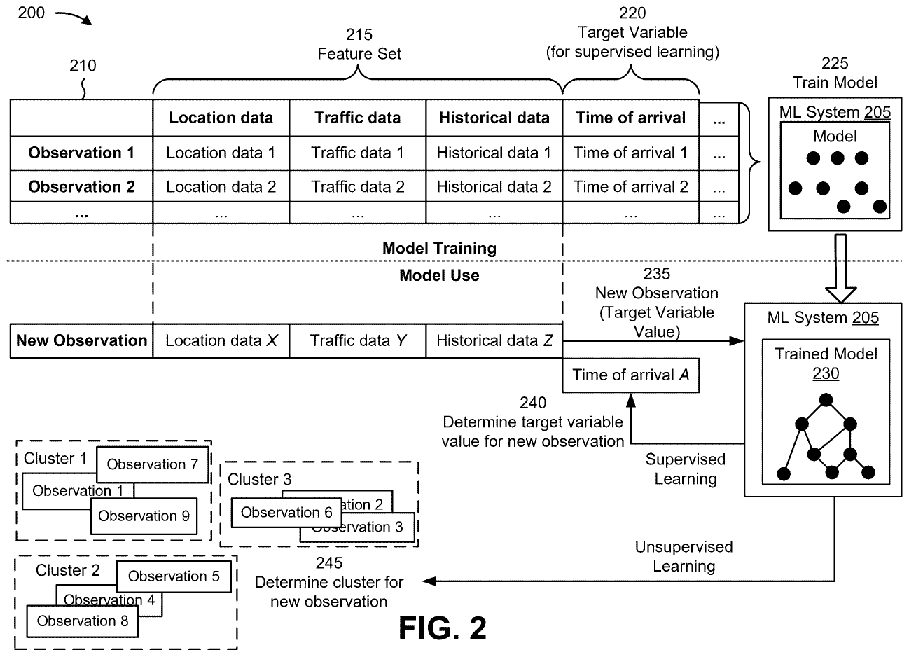

FIG. 2 is a diagram illustrating an example 200 of training and using a machine learning model for providing proactive beam forming based on a location of a network-connected device. The machine learning model training and usage described herein may be performed using a machine learning system. The machine learning system may include or may be included in a computing device, a server, a cloud computing environment, and/or the like, such as the mediator system 115 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the mediator system 115, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the mediator system 115. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of location data, a second feature of traffic data, a third feature of historical data, and so on. As shown, for a first observation, the first feature may have a value of location data 1, the second feature may have a value of traffic data 1, the third feature may have a value of historical data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “time of arrival” and may include a value of time of arrival 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of location data X, a second feature of traffic data Y, a third feature of historical data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of time of arrival A for the target variable of the time of arrival for the new observation, as shown by reference numbers 235 and 240. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 245. The observations within a cluster may have a threshold degree of similarity. As an example, if the machine learning system classifies the new observation in a first cluster (e.g., a location data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a traffic data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to provide proactive beam forming based on a location of a network-connected device. The machine learning system enables recognition and/or identification of tens, hundreds, thousands, or millions of features and/or feature values for tens, hundreds, thousands, or millions of observations, thereby increasing accuracy and consistency and reducing delay associated with providing proactive beam forming based on a location of a network-connected device relative to requiring computing resources to be allocated for tens, hundreds, or thousands of operators to manually provide proactive beam forming based on a location of a network-connected device.

As indicated above, FIG. 2 is provided as an example. Other examples may differ from what is described in connection with FIG. 2.

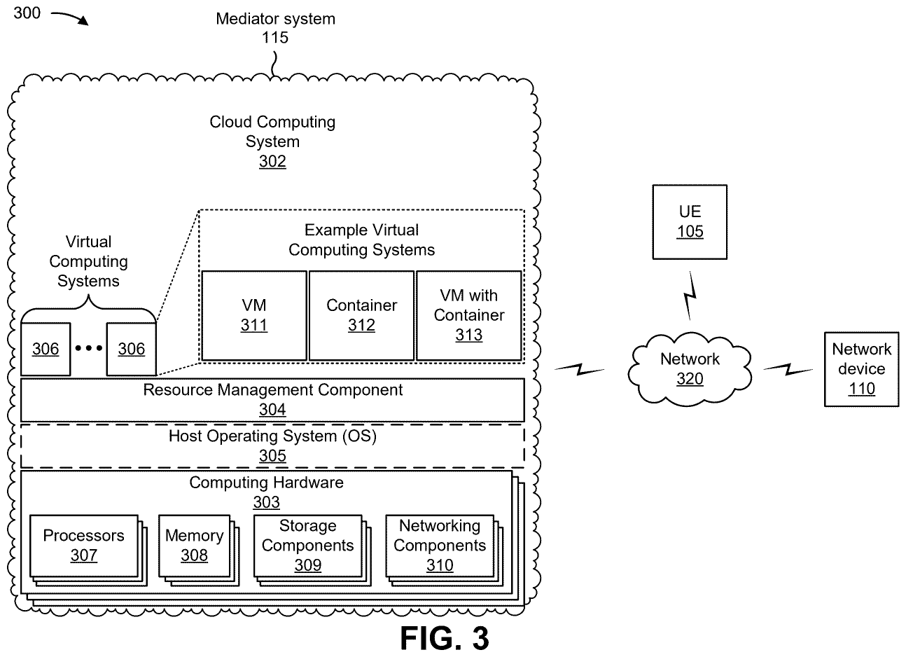

FIG. 3 is a diagram of an example environment 300 in which systems and/or methods described herein may be implemented. As shown in FIG. 3, the environment 300 may include the mediator system 115, which may include one or more elements of and/or may execute within a cloud computing system 302. The cloud computing system 302 may include one or more elements 303-313, as described in more detail below. As further shown in FIG. 3, the environment 300 may include the UE 105, the network device 110, and/or a network 320. Devices and/or elements of the environment 300 may interconnect via wired connections and/or wireless connections.

The UE 105 may include one or more devices capable of receiving, generating, storing, processing, and/or providing information, as described elsewhere herein. The UE 105 may include a communication device and/or a computing device. For example, the UE 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network device 110 may include one or more devices capable of receiving, processing, storing, routing, and/or providing traffic (e.g., a packet and/or other information or metadata) in a manner described herein. For example, the network device 110 may include a router, such as a label switching router (LSR), a label edge router (LER), an ingress router, an egress router, a provider router (e.g., a provider edge router or a provider core router), a virtual router, a home router, or another type of router. Additionally, or alternatively, the network device 110 may include a gateway, a switch, a firewall, a hub, a bridge, a reverse proxy, a server (e.g., a proxy server, a cloud server, or a data center server), a load balancer, a wireless access point (WAP), and/or a similar device. In some implementations, the network device 110 may be a physical device implemented within a housing, such as a chassis. In some implementations, the network device 110 may be a virtual device implemented by one or more computing devices of a cloud computing environment or a data center. In some implementations, a group of network devices 110 may be a group of data center nodes that are used to route traffic flow through a network.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

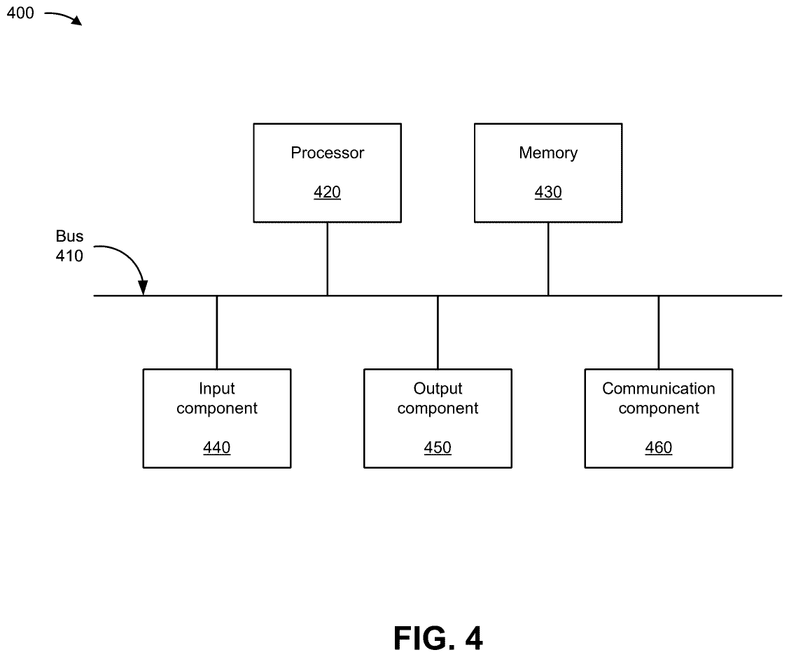

Although the mediator system 115 may include one or more elements 303-313 of the cloud computing system 302, may execute within the cloud computing system 302, and/or may be hosted within the cloud computing system 302, in some implementations, the mediator system 115 may not be cloud-based (e.g., may be implemented outside of a cloud computing system) or may be partially cloud-based. For example, the mediator system 115 may include one or more devices that are not part of the cloud computing system 302, such as the device 400 of FIG. 4, which may include a standalone server or another type of computing device. The mediator system 115 may perform one or more operations and/or processes described in more detail elsewhere herein.

The network 320 may include one or more wired and/or wireless networks. For example, the network 320 may include a cellular network (e.g., a 5G network, a 4G network, a long term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 320 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the UE 105, the network device 110, and/or the mediator system 115. In some implementations, the UE 105, the network device 110, and/or the mediator system 115 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

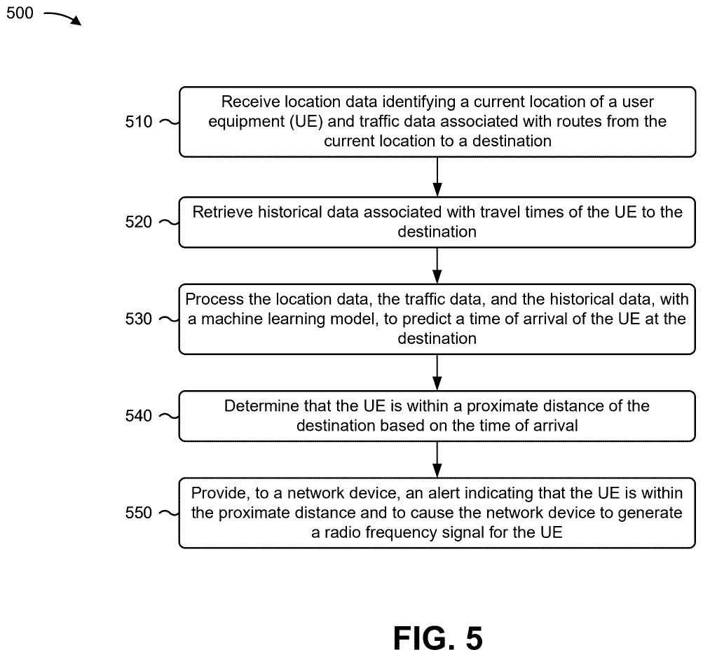

FIG. 5 is a flowchart of an example process 500 for proactive beam forming based on a location of a network-connected device. In some implementations, one or more process blocks of FIG. 5 may be performed by a device (e.g., the mediator system 115). In some implementations, one or more process blocks of FIG. 5 may be performed by another device or a group of devices separate from or including the device, such as a UE (e.g., the UE 105) and/or a network device (e.g., the network device 110). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving location data identifying a current location of a UE and traffic data associated with routes from the current location to a destination (block 510). For example, the device may receive location data identifying a current location of a UE and traffic data associated with routes from the current location to a destination, as described above. In some implementations, the UE is a mobile telephone provided in a vehicle or is a vehicle communication system provided in the vehicle.

As further shown in FIG. 5, process 500 may include retrieving historical data associated with travel times of the UE to the destination (block 520). For example, the device may retrieve historical data associated with travel times of the UE to the destination, as described above.

As further shown in FIG. 5, process 500 may include processing the location data, the traffic data, and the historical data, with a model, to predict a time of arrival of the UE at the destination (block 530). For example, the device may process the location data, the traffic data, and the historical data, with a model, to predict a time of arrival of the UE at the destination, as described above.

As further shown in FIG. 5, process 500 may include determining that the UE is within a proximate distance of the destination based on the time of arrival (block 540). For example, the device may determine that the UE is within a proximate distance of the destination based on the time of arrival, as described above.

As further shown in FIG. 5, process 500 may include providing, to a network device, an alert indicating that the UE is within the proximate distance and to cause the network device to generate a radio frequency signal for the UE (block 550). For example, the device may provide, to a network device, an alert indicating that the UE is within the proximate distance and to cause the network device to generate a radio frequency signal for the UE, as described above. In some implementations, the network device utilizes the radio frequency signal to communicate with and authenticate the UE. In some implementations, the UE is connected to a telecommunications network prior to connecting to the network device via the radio frequency signal.

In some implementations, process 500 includes providing, to the network device, the time of arrival and a direction of travel of the UE to cause the network device to calculate a direction and a power of the radio frequency signal. In some implementations, process 500 includes receiving updated location data and updated traffic data prior to the time of arrival, and processing the updated location data, the updated traffic data, and the historical data, with the model, to predict an updated time of arrival.

In some implementations, process 500 includes receiving environmental data identifying environmental conditions associated with the UE location and the network device, and processing the location data, the traffic data, the historical data, and the environmental data, with the model, to predict the time of arrival of the UE at the destination. In some implementations, process 500 includes utilizing the environmental data to generate a recommended direction and a recommended power of the radio frequency signal, and providing the recommended direction and the recommended power to the network device.

In some implementations, process 500 includes providing an authentication token to the UE based on determining that the UE is within the proximate distance of the destination, wherein the authentication token authenticates the UE with the network device. In some implementations, process 500 includes determining a travel time associated with the UE traveling from the current location to the destination, and storing the travel time with the historical data in a data structure.

In some implementations, process 500 includes providing, to the UE and based on determining that the UE is within the proximate distance of the destination, a notification indicating an imminent connection to the network device. In some implementations, process 500 includes calculating a direction and a power of the radio frequency signal based on the time of arrival and a direction of travel of the UE, and instructing the network device to utilize the direction and the power to generate the radio frequency signal. In some implementations, process 500 includes receiving, from the UE and the network device, feedback associated with the time of arrival of the UE at the destination, and retraining the model based on the feedback.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, location data identifying a current location of a user equipment (UE) and traffic data associated with routes from the current location to a destination;
retrieving, by the device, historical data associated with travel times of the UE to the destination;
processing, by the device, the location data, the traffic data, and the historical data, with a model, to predict a time of arrival of the UE at the destination;
determining, by the device, that the UE is within a proximate distance of the destination based on the time of arrival; and
providing, by the device and to a network device, an alert indicating that the UE is within the proximate distance and to cause the network device to generate a radio frequency signal for the UE.

2. The method of claim 1, further comprising:
providing, to the network device, the time of arrival and a direction of travel of the UE to cause the network device to calculate a direction and a power of the radio frequency signal.

3. The method of claim 1, wherein the network device utilizes the radio frequency signal to communicate with and authenticate the UE.

4. The method of claim 1, further comprising:
receiving updated location data and updated traffic data prior to the time of arrival; and
processing the updated location data, the updated traffic data, and the historical data, with the model, to predict an updated time of arrival.

5. The method of claim 1, further comprising:
receiving environmental data identifying environmental conditions associated with the UE location and the network device,
wherein processing the location data, the traffic data, and the historical data, with the model, to predict the time of arrival of the UE at the destination comprises:
processing the location data, the traffic data, the historical data, and the environmental data, with the model, to predict the time of arrival of the UE at the destination.

6. The method of claim 5, further comprising:
utilizing the environmental data to generate a recommended direction and a recommended power of the radio frequency signal; and
providing the recommended direction and the recommended power to the network device.

7. The method of claim 1, further comprising:
providing an authentication token to the UE based on determining that the UE is within the proximate distance of the destination,
wherein the authentication token authenticates the UE with the network device.

8. A device, comprising:
one or more processors configured to:
receive location data identifying a current location of a user equipment (UE) and traffic data associated with routes from the current location to a destination;
retrieve historical data associated with travel times of the UE to the destination;
process the location data, the traffic data, and the historical data, with a model, to predict a time of arrival of the UE at the destination;
determine that the UE is within a proximate distance of the destination based on the time of arrival;
provide an authentication token to the UE based on determining that the UE is within the proximate distance of the destination; and
provide, to a network device, an alert indicating that the UE is within the proximate distance and to cause the network device to generate a radio frequency signal for the UE.

9. The device of claim 8, wherein the one or more processors are further configured to:
determine a travel time associated with the UE traveling from the current location to the destination; and
store the travel time with the historical data in a data structure.

10. The device of claim 8, wherein the one or more processors are further configured to:
provide, to the UE and based on determining that the UE is within the proximate distance of the destination, a notification indicating an imminent connection to the network device.

11. The device of claim 8, wherein the UE is a mobile telephone provided in a vehicle or is a vehicle communication system provided in the vehicle.

12. The device of claim 8, wherein the UE is connected to a telecommunications network prior to connecting to the network device via the radio frequency signal.

13. The device of claim 8, wherein the one or more processors are further configured to:
calculate a direction and a power of the radio frequency signal based on the time of arrival and a direction of travel of the UE; and
instruct the network device to utilize the direction and the power to generate the radio frequency signal.

14. The device of claim 8, wherein the one or more processors are further configured to:
receive, from the UE and the network device, feedback associated with the time of arrival of the UE at the destination; and
retrain the model based on the feedback.

15. A non-transitory computer-readable medium storing a set of instructions, the set of instructions comprising:
one or more instructions that, when executed by one or more processors of a device, cause the device to:
receive location data identifying a current location of a user equipment (UE) and traffic data associated with routes from the current location to a destination,
wherein the UE is a mobile telephone provided in a vehicle or is a vehicle communication system provided in the vehicle;
retrieve historical data associated with travel times of the UE to the destination;
process the location data, the traffic data, and the historical data, with a model, to predict a time of arrival of the UE at the destination;
determine that the UE is within a proximate distance of the destination based on the time of arrival; and
provide, to a network device, an alert indicating that the UE is within the proximate distance and to cause the network device to generate a radio frequency signal for the UE.

16. The non-transitory computer-readable medium of claim 15, wherein the one or more instructions further cause the device to:
receive updated location data and updated traffic data prior to the time of arrival; and
process the updated location data, the updated traffic data, and the historical data, with the model, to predict an updated time of arrival.

17. The non-transitory computer-readable medium of claim 15, wherein the one or more instructions further cause the device to:
provide an authentication token to the UE based on determining that the UE is within the proximate distance of the destination,
wherein the authentication token authenticates the UE with the network device.

18. The non-transitory computer-readable medium of claim 15, wherein the one or more instructions further cause the device to:
provide, to the UE and based on determining that the UE is within the proximate distance of the destination, a notification indicating an imminent connection to the network device.

19. The non-transitory computer-readable medium of claim 15, wherein the one or more instructions further cause the device to:
calculate a direction and a power of the radio frequency signal based on the time of arrival and a direction of travel of the UE; and
instruct the network device to utilize the direction and the power to generate the radio frequency signal.

20. The non-transitory computer-readable medium of claim 15, wherein the one or more instructions further cause the device to:
receive, from the UE and the network device, feedback associated with the time of arrival of the UE at the destination; and
retrain the model based on the feedback.
